(19) United States
(12) Patent Application Publication
(10) Pub. No.: US 2026/0302370 A1
(43) Pub. Date: Oct. 1, 2026

(54) APPARATUS AND METHOD FOR MANUFACTURING SECONDARY BATTERY

(71) Applicant: SAMSUNG SDI CO., LTD., Yongin-si (KR)

(72) Inventors: Jun Yeong CHOI, Yongin-si (KR); Hyung Chun LEE, Yongin-si (KR)

(21) Appl. No.: 19/442,161

(22) Filed: Jan. 7, 2026

(30) Foreign Application Priority Data
Mar. 31, 2025 (KR) 10-2025-0041654

(51) Int. Cl. H01M 10/0587; H01M 10/052; H01M 50/655

(52) U.S. Cl. CPC H01M 10/0587; H01M 10/052; H01M 50/655

(57) ABSTRACT

An apparatus for manufacturing a secondary battery, the apparatus including a first liquid injector for firstly injecting an electrolyte into an interior of a cell assembly including a cap assembly and a battery can, which are mutually connected, the battery can accommodating an electrode assembly therein, a charger configured to charge the cell assembly after firstly injecting the electrolyte is completed, a loss amount determination part configured to determine a change in weight of the cell assembly before and after charging and determine, resulting in a determination result, a loss amount of the electrolyte according to the charging based on the determination result, and a supplementary liquid injection unit configured to supplement the electrolyte as much as the loss amount to the cell assembly.

### CROSS-REFERENCE TO RELATED APPLICATION

This application claims priority to and the benefit of Korean Patent Application No. 10-2025-0041654, filed on Mar. 31, 2025, the disclosure of which is incorporated herein by reference in its entirety.

### BACKGROUND

### 1. Field

The present disclosure relates to an apparatus and method for manufacturing a secondary battery.

### 2. Description of Related Art

Unlike primary batteries that cannot be recharged, secondary batteries are batteries that can be charged and discharged. A secondary battery includes an electrode assembly formed of a positive electrode plate, a negative electrode plate, and a separator, a battery can that accommodates the electrode assembly, and a cap assembly. The electrode assembly may be classified as a winding type electrode assembly and a stack type electrode assembly according to a stacking form of the electrode plates and the separator. A manufacturing process of the secondary battery includes a process of inserting the electrode assembly into the battery can, electrically connecting the electrode assembly to an external terminal, injecting an electrolyte, and then precharging the electrode assembly.

The above information disclosed in this Background section is for enhancement of understanding of the background of the present disclosure, and therefore, it may contain information that does not constitute a related (or prior) art.

### SUMMARY

Embodiments include an apparatus for manufacturing a secondary battery, the apparatus including a first liquid injector for firstly injecting an electrolyte into an interior of a cell assembly including a cap assembly and a battery can, which are mutually connected, the battery can accommodating an electrode assembly therein, a charger configured to charge the cell assembly after firstly injecting the electrolyte is completed, a loss amount determination part configured to determine a change in weight of the cell assembly before and after charging and determine, resulting in a determination result, a loss amount of the electrolyte according to the charging based on the determination result, and a supplementary liquid injection unit configured to supplement the electrolyte by the loss amount to the cell assembly.

The supplementary liquid injection unit may include a measurement part configured to measure the electrolyte by the loss amount, and a supplementary liquid injection hopper configured to accommodate the electrolyte measured by the measurement part and transfer the electrolyte to the cell assembly.

The measurement part may include a weight measurement module configured to measure a weight of the supplementary liquid injection hopper.

The supplementary liquid injection unit may further include an electrolyte accommodation part connected to the supplementary liquid injection hopper through a supply pipe and configured to transfer the electrolyte to the supplementary liquid injection hopper, and a controller connected to the measurement part and the loss amount determination part, the controller being configured to control a flow rate of the electrolyte moving from the electrolyte accommodation part to the supplementary liquid injection hopper.

A flow rate control valve on the supply pipe may be opened and closed by the controller.

The supplementary liquid injection unit may further include a vacuum chamber connected to the cell assembly, the supplementary liquid injection unit being configured to discharge a gas inside the cell assembly.

The supplementary liquid injection hopper may be connected to the vacuum chamber through a liquid injection pipe, and the electrolyte inside the supplementary liquid injection hopper may transferred, after passing through the liquid injection pipe, to the cell assembly through the vacuum chamber.

The supplementary liquid injection unit may include an electrolyte accommodation part connected to the cell assembly through a liquid injection pipe, a pump configured to supply the electrolyte of the electrolyte accommodation part to the cell assembly, a flow meter configured to measure a flow rate of the electrolyte moving to the cell assembly, and a controller connected to the loss amount determination part and the flow meter, the controller being configured to supply the electrolyte by the loss amount calculated through the loss amount determination part to the cell assembly.

The supplementary liquid injection unit may further include a gas discharge part connected to the cell assembly and configured to discharge a gas inside the cell assembly.

The gas discharge part may include a vacuum chamber connected to the cell assembly through a discharge pipe.

The apparatus may further include a pressure regulator configured to control a pressure of an interior of the vacuum chamber.

The supplementary liquid injection unit may include an electrolyte accommodation part connected to the cell assembly through a liquid injection pipe, a pump configured to supply the electrolyte of the electrolyte accommodation part to the cell assembly, a weight change detector configured to detect a weight change of the cell assembly in real time, and a controller connected to the weight change detector, the controller being configured to drive the pump until the weight measured by the weight change detector becomes equal to a weight of the cell assembly into which the first liquid injection is completed.

The supplementary liquid injection unit may further include a gas discharge part connected to the cell assembly, the supplemental liquid injection unit being configured to discharge a gas inside the cell assembly.

The gas discharge part may include a vacuum chamber connected to the cell assembly through a discharge pipe.

The supplementary liquid injection unit may include an electrolyte accommodation part connected to the cell assembly through a liquid injection pipe, a quantitative chamber configured to temporarily accommodate the electrolyte of the electrolyte accommodation part transferred by a pump, a volume detector configured to measure a volume of the electrolyte inside the quantitative chamber, a controller connected to the loss amount determination part and the volume detector, the controller being configured to stop the pump when the volume of the electrolyte inside the quantitative chamber becomes equal to a loss amount determined through the loss amount determination part, and a quantitative injector configured to supply the electrolyte inside the quantitative chamber to the cell assembly.

The supplementary liquid injection unit may further include a gas discharge part connected to the cell assembly, the supplemental liquid injection unit being configured to discharge a gas inside the cell assembly, which occurs during charging.

The gas discharge part may include a vacuum chamber connected to the cell assembly through a discharge pipe.

A secondary battery manufactured by the apparatus for manufacturing a secondary battery.

Embodiments include a method of manufacturing a secondary battery, the method including firstly injecting an electrolyte into an interior of a cell assembly including a cap assembly and a battery can, which are mutually connected, the battery can accommodating an electrode assembly therein, measuring a first weight of the cell assembly after the firstly injecting is completed, charging the cell assembly on which the first weight measurement operation is completed, re-measuring the weight of the cell assembly after charging the cell assembly is completed, comparing the re-measured weight with the first weight and determining a loss amount of the electrolyte according to the charging, and supplementing the electrolyte by the loss amount into the battery can.

The method may further include, before supplementing the electrolyte is performed, removing a gas inside the cell assembly.

### BRIEF DESCRIPTION OF THE DRAWINGS

Features will become apparent to those of ordinary skill in the art by describing in detail exemplary embodiments with reference to the attached drawings, in which:

FIG. 1 is a perspective view illustrating a secondary battery manufactured by a method of manufacturing a secondary battery according to one or more embodiments of the present disclosure;

FIG. 2 is a cross-sectional view illustrating the secondary battery shown in FIG. 1;

FIG. 3 is a diagram illustrating a basic structure of an apparatus for manufacturing a secondary battery according to one or more embodiments of the present disclosure;

FIG. 4 is a block diagram for describing an operation method of the apparatus for manufacturing a secondary battery according to one or more embodiments of the present disclosure;

FIG. 5 is a flowchart illustrating a method of manufacturing a secondary battery according to one or more embodiments of the present disclosure;

FIGS. 6 to 11 are graphical diagrams illustrating the method of manufacturing a secondary battery according to one or more embodiments of the present disclosure;

FIG. 12 is a block diagram illustrating a modified example of the apparatus for manufacturing a secondary battery according to one or more embodiments of the present disclosure;

FIG. 13 is a diagram illustrating a modified example of the apparatus for manufacturing a secondary battery shown in FIG. 12;

FIG. 14 is a diagram illustrating another modified example of the apparatus for manufacturing a secondary battery according to one or more embodiments of the present disclosure;

FIG. 15 is a diagram illustrating a modified example of the manufacturing apparatus shown in FIG. 14;

FIG. 16 is a diagram illustrating still another modified example of the apparatus for manufacturing a secondary battery according to one or more embodiments of the present disclosure;

FIG. 17 is a diagram illustrating a modified example of the manufacturing apparatus shown in FIG. 16;

FIG. 18 is a perspective view illustrating a secondary battery pack having the secondary battery manufactured by the apparatus for manufacturing a secondary battery according to one or more embodiments of the present disclosure; and

FIG. 19 is a diagram illustrating an application example of the secondary battery of FIG. 18.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

The terms or words used in the present specification and claims are not to be narrowly interpreted according to their general or dictionary meanings and should be interpreted as having meanings and concepts that are consistent with the technical idea of the present disclosure on the basis of the principle that an inventor can be his/her own lexicographer to appropriately define concepts of terms to describe his/her disclosure in the best way. The embodiments described in this specification and the configurations shown in the drawings are only some embodiments of the present disclosure and do not represent all of the aspects, features, and embodiments of the present disclosure. Accordingly, it should be understood that there may be various equivalents and modifications that can replace or modify one or more embodiments or features therein described herein at the time of filing this application.

It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

References to two compared elements, features, etc. as being “the same” may mean that they are “substantially the same.” Thus, the phrase “substantially the same” may include a case having a deviation that is considered low in the art, for example, a deviation of 5% or less. In addition, uniformity of a parameter in a predetermined region may imply uniformity from an average perspective.

Although the terms first, second, and the like are used to describe various components, these components are substantially not limited by these terms. These terms are only used for distinguishing one component from another component, and unless otherwise stated, it is of course that a first component may also be a second component.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.”

As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list.

Throughout the specification, if “A and/or B” is stated, it means A, B or A and B, unless otherwise stated and if “C to D” is stated, it means C or more and D or less, unless otherwise stated.

When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C.

As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below.

The terminology used herein is for the purpose of describing embodiments of the present disclosure and is not intended to limit the present disclosure.

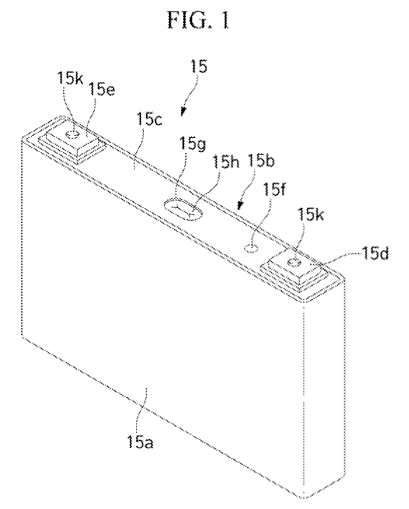

FIG. 1 is a perspective view illustrating a secondary battery 15 manufactured by a method of manufacturing a secondary battery according to embodiments of the present disclosure.

The secondary battery 15 may include a battery can 15a, a cap assembly 15b, an electrode assembly 15r, and an electrolyte 100. The electrode assembly 15r may be immersed in the electrolyte 100 which is injected inside the battery can 15a.

The battery can 15a forms the overall exterior of a prismatic secondary battery and may be formed of a conductive metal such as aluminum, an aluminum alloy, or a nickel-plated steel. In addition, the battery can 15a may provide a space in which the electrode assembly and the electrolyte are accommodated.

The cap assembly 15b may include a cap plate 15c covering an opening of the battery can 15a. In some embodiments, each of the battery can 15a and the cap plate 15c may be formed of a conductive material. The positive electrode terminal 15d and the negative electrode terminal 15e may be electrically connected to a positive electrode tab and a negative electrode tab of an inside, respectively, and be exposed to an outer side of the cap plate 15c.

An electrolyte injection hole 15f may be formed in the cap plate 15c, a vent hole 15g may be open, and a vent, i.e., a vent part 15h, may be bonded to the vent hole 15g. The vent part 15h is opened by a gas generated inside the battery and performs degassing.

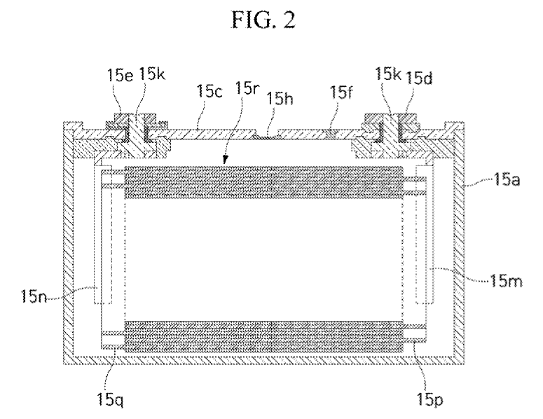

FIG. 2 is a cross-sectional view illustrating the secondary battery shown in FIG. 1.

The electrode assembly 15r can be formed by winding or stacking a first electrode plate, a separator, and a second electrode plate formed in a plate shape or film shape. When the electrode assembly 15r is a wound type, a winding axis may be parallel to the longitudinal direction of the battery can. In some other embodiments, the electrode assembly 15r is a stack type rather than a winding type. The shape of the electrode assembly 15r may vary.

In addition, the electrode assembly 15r may be a Z-stack electrode assembly in which a positive electrode plate and a negative electrode plate are inserted into both sides of a separator, which is then bent into a Z-stack. In addition, one or more of the electrode assembly 15r may be stacked such that long sides of the one or more of the electrode assembly 15r are adjacent to each other and accommodated in the battery can, and the number of the electrode assembly 15r in the battery can may vary. The first electrode plate of the electrode assembly 15r may act as a negative electrode, and the second electrode plate may act as a positive electrode. Of course, the reverse is also possible.

The first electrode plate may be formed by applying a first electrode active material, such as graphite, carbon, or the like, to a first electrode current collector formed of a metal foil, such as copper, a copper alloy, nickel, a nickel alloy, or the like. The first electrode plate may include a first electrode tab 15p (e.g., a first uncoated portion) that is a region to which the first electrode active material is not applied. The first electrode tab 15p may act as a current flow path between the first electrode plate and the first current collector 15m. In some embodiments, when the first electrode plate is manufactured, the first electrode tab 15p is formed by being cut in advance to protrude to one side of the electrode assembly, or the first electrode tab protrudes to one side of the electrode assembly more than (e.g., farther than or beyond) the separator without being separately cut.

The second electrode plate may be formed by applying a second electrode active material, such as a transition metal oxide, on a second electrode current collector formed of a metal foil, such as aluminum or an aluminum alloy. The second electrode plate may include a second electrode tab 15q (e.g., a second uncoated portion) that is a region to which the second electrode active material is not applied. The second electrode tab 15q may act as a current flow path between the second electrode plate and the second current collector 15n. In some embodiments, the second electrode tab 15q may be formed by being cut in advance to protrude to the other side (e.g., the opposite side) of the electrode assembly when the second electrode plate is manufactured, or the second electrode plate may protrude to the other side of the electrode assembly more than (e.g., farther than or beyond) the separator without being separately cut.

In FIG. 2, the first electrode tab 15p and the second electrode tab 15q are illustrated as being positioned on the right side and the left side of the electrode assembly 15r, respectively. However, in some other embodiments, both the first electrode tab 15p and the second electrode tab 15q may be positioned together either on the right side or on the left side of the electrode assembly 15r.

Here, the left side and the right side of the electrode assembly 15r are based on the battery illustrated in FIG. 2 for convenience of explanation. The left side refers to the side of the vertical surface of the electrode assembly 15r to which the second current collector 15n is joined, and the right side refers to the opposite side to which the first current collector 15m is joined. Therefore, the terms “left side” and “right side” of the electrode assembly 15r used above may change their names when the battery rotates left and right or up and down.

The separator prevents or substantially reduces instances of a short circuit between the first electrode and the second electrode while allowing movement of lithium ions therebetween. The separator may be made of, for example, a polyethylene film, a polypropylene film, a polyethylene-polypropylene film, or the like.

In some embodiments, an electrode assembly 15r is accommodated in the battery can 15a along with an electrolyte.

In the electrode assembly 15r, the first current collector 15m and the second current collector 15n may be welded and connected to the first electrode tab 15p extending from the first electrode plate and the second electrode tab 15q extending from the second electrode plate, respectively.

The first current collector 15m and the second current collector 15n are connected to the positive electrode terminal 15d and the negative electrode terminal 15e through connection members 15k, respectively. In some embodiments, the connection members 15k may each have an outer peripheral surface that is threaded, and may be fastened to the positive electrode terminal 15d and the negative electrode terminal 15e by screwing. However, the connection members 15k may also be coupled to the positive electrode terminal 15d and the negative electrode terminal 15e by riveting or welding.

Hereinafter, suitable materials that may be usable for the secondary battery according to embodiments of the present disclosure will be described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel oxide, a lithium cobalt oxide, a lithium manganese oxide, a lithium iron phosphate compound, a cobalt-free nickel-manganese oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a substrate and a positive electrode active material layer formed on the substrate. The positive electrode active material layer may include a positive electrode active material and may further include a binder and/or a conductive material.

The content of the positive electrode active material is in a range of about 90 wt% to about 99.5 wt% on the basis of 100 wt% of the positive electrode active material layer, and the content of the binder and the conductive material is in a range of about 0.5 wt% to about 5 wt%, respectively, on the basis of 100 wt% of the positive electrode active material layer.

The substrate may be aluminum (Al) but the material of the substrate may vary.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si negative electrode active material or a Sn negative electrode active material may be used as the material capable of being doped and undoped with lithium. The Si negative electrode active material may be silicon, a silicon-carbon composite, SiOₓ (0<x≤2), a Si alloy, or a combination thereof.

The silicon-carbon composite may be a composite of silicon and amorphous carbon. According to one or more embodiments, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a substrate and a negative electrode active material layer disposed on the substrate. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose compound capable of imparting viscosity may be further included.

As the negative electrode substrate, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate, an ester, an ether, a ketone, an alcohol solvent, an aprotic solvent, and may be used alone or in combination of two or more.

In addition, when a carbonate solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film including two or more layers thereof may be used.

The separator may include a porous substrate and a coating layer including an organic material, an inorganic material, or a combination thereof on one or both surfaces of the porous substrate.

The organic material may include a polyvinylidene fluoride polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃,SrTiO₃, BaTiO₃, Mg(OH)₂, boehmite, and combinations thereof, but this may vary.

The organic material and the inorganic material may be mixed in one coating layer or may be in the form of a coating layer including (or containing) an organic material and a coating layer including (or containing) an inorganic material that are stacked on each other.

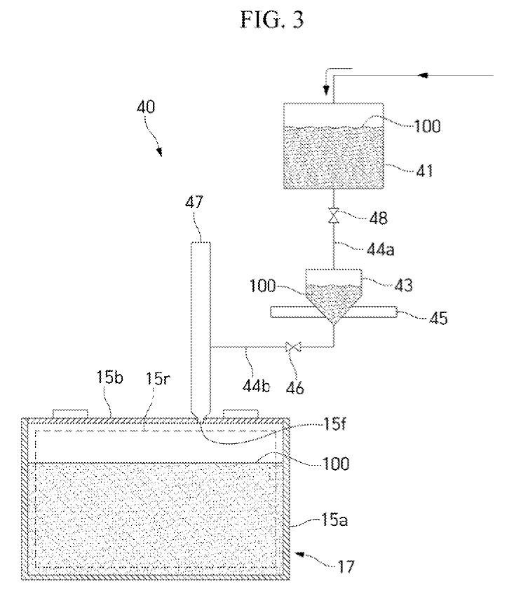

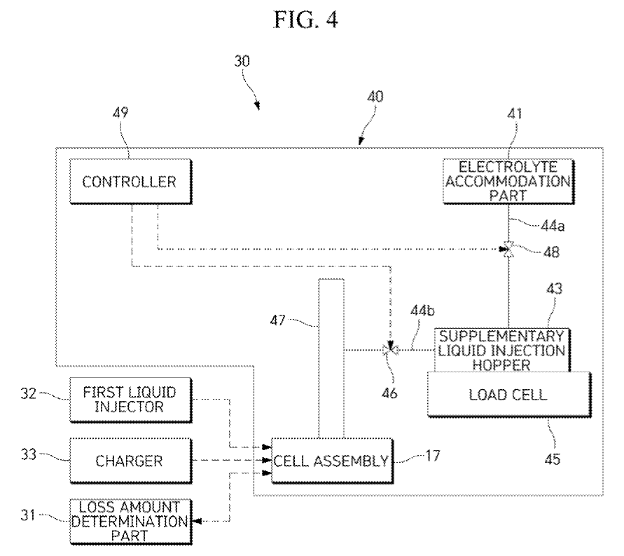

FIG. 3 is a diagram illustrating a basic structure of an apparatus 30 (see FIG. 4) for manufacturing a secondary battery according to one or more embodiments of the present disclosure. FIG. 4 is a block diagram for describing an operation method of the apparatus for manufacturing a secondary battery according to one or more embodiments of the present disclosure.

As shown in the drawings, the apparatus 30 for manufacturing a secondary battery according to the present embodiment may include a first liquid injector 32, a charger 33, a loss amount determination part 31, and a supplementary liquid injection unit 40. FIG. 3 shows that some of the electrolyte in a cell assembly 17 are lost.

The first liquid injector 32 is a device for injecting the electrolyte 100 into an interior of the cell assembly 17. The cell assembly 17 in the present description refers to an assembly in which the battery can 15a and the cap assembly 15b are mutually coupled and accommodate the electrode assembly 15r. The first liquid injector 32 injects the electrolyte 100 into the battery can 15a and immerses the electrode assembly 15r in the electrolyte 100. The liquid injection method of the first liquid injector 32 may follow the general method. The electrolyte injection hole 15f is formed in the cap assembly 15b. The electrolyte may be injected through the electrolyte injection hole 15f. In addition, a gas generated by a chemical reaction during precharging may be discharged to the outside through the electrolyte injection hole 15f.

The charger 33 may charge the cell assembly 17 into which the first liquid injection is completely carried out. The charging may be achieved by connecting the charger 33 to the positive electrode terminal 15d and the negative electrode terminal 15e of the cell assembly 17 and then applying power.

However, when a charging current is applied to the cell assembly 17, the electrolyte may be lost because the electrolyte and the electrode react when they first meet. For example, since a solid electrolyte interphase (SEI) layer is formed on a surface of a negative electrode immersed in the electrolyte, the electrolyte is electrochemically decomposed, and some of the electrolyte is vaporized, a loss occurs. The objective of the manufacturing device of the present embodiment is to determine a loss amount of the electrolyte, which occurs during first charging, and to supplement the electrolyte as much as the loss amount (e.g., by the amount lost).

The loss amount of the electrolyte may be measured by the loss amount determination part 31. The loss amount determination part 31 may determine a change in weight of the cell assembly 17 before and after the charging and determine a loss amount of the electrolyte according to the charging on the basis of the determination result. An amount of the electrolyte to be supplemented may be determined through the loss amount determination part 31.

In other words, the principle of determining the loss amount in the loss amount determination part 31 is a weight change of the cell assembly 17 in a state in which the electrolyte is injected. The loss amount determination part 31 sequentially measures weights of the cell assembly 17 after the electrolyte injection and before the first charging and determines a weight change value. The loss amount of the electrolyte may be determined on the basis of the reduced weight of the cell assembly 17. Since a density of the electrolyte is known, the loss weight of the electrolyte as well as a volume thereof may be determined through the reduced weight value. For example, it may be determined that how many cc of the electrolyte is injected.

The loss amount determination part 31 may include a weight measuring device. The loss amount determination part 31 may be connected to a controller 49. That is, the data determined in the loss amount determination part 31 may be transmitted to the controller 49.

The supplementary liquid injection unit 40 may supplement the loss amount of the electrolyte during the first charging to the cell assembly. The supplementary liquid injection unit 40 may include an electrolyte accommodation part 41, a supplementary liquid injection hopper 43, a load cell 45, a vacuum chamber 47, and the controller 49.

The electrolyte accommodation part 41 may be an electrolyte tank storing an externally supplied electrolyte. The electrolyte accommodation part 41 may be connected to the supplementary liquid injection hopper 43 though a supply pipe 44a. The electrolyte inside the electrolyte accommodation part 41 may be moved in a set amount to the supplementary liquid injection hopper 43 through the supply pipe 44a. A flow rate control valve 48 may be installed in the supply pipe 44a. The flow rate control valve 48 is a valve controlled by the controller 49. When the flow rate control valve 48 is opened, the electrolyte may be supplied to the supplementary liquid injection hopper 43. In addition, when the flow rate control valve 48 is closed, the supply of the electrolyte may be cut off.

The controller 49 may be connected to a measurement part, which will be described below, and the loss amount determination part 31, and may control a flow rate of the electrolyte moving from the electrolyte accommodation part to the supplementary liquid injection hopper. The control of the flow rate may be accomplished through the flow rate control valve 48.

The supplementary liquid injection hopper 43 may temporarily accommodate the electrolyte supplied from the electrolyte accommodation part 41. An amount of the electrolyte supplied to the supplementary liquid injection hopper 43 is equal to an amount to be supplemented to the cell assembly 17.

The measurement part may measure a weight of the electrolyte accommodated in the supplementary liquid injection hopper 43 in real time. Only an amount of the electrolyte as much as a loss amount may be introduced into the supplementary liquid injection hopper 43 by the measurement part. The measurement part in the present embodiment may be a weight measurement module that measures a weight of the supplementary liquid injection hopper 43. More specifically, the measurement part may be a load cell 45 that measures the weight of the supplementary liquid injection hopper 43. The load cell 45 may measure the weight of the supplementary liquid injection hopper 43 and transmit the measured data to the controller 49. Weight data of a supplementary liquid injection hopper 43 that is empty and the supplementary liquid injection hopper 43 filled with the electrolyte is transmitted to the controller 49.

Loss amount information of the electrolyte (a loss weight of the electrolyte) transmitted from the loss amount determination part 31 is stored in the controller 49. In this state, weight information of the electrolyte filling in the supplementary liquid injection hopper 43 may be received from the load cell 45 in real time. The controller 49 opens the flow rate control valve 48 until the weight of the electrolyte filling in the supplementary liquid injection hopper 43 becomes equal to the loss weight of the electrolyte. In addition, the flow rate control valve 48 may be blocked at an instant when the weights become the same.

Consequently, the controller 49 may supply a required amount of the electrolyte to the supplementary liquid injection hopper 43 on the basis of the weight information transmitted from the loss amount determination part 31 and the load cell 45. The supplementary liquid temporarily stored in the supplementary liquid injection hopper 43 may be transferred to the cell assembly 17.

Meanwhile, as shown in FIG. 3, a spout of the vacuum chamber 47 may be connected to the electrolyte injection hole 15f of the cell assembly 17. The vacuum chamber 47 is a tube that provides a negative pressure and may suction a gas inside the cell assembly. The gas inside the cell assembly 17 may move from the cell assembly to the vacuum chamber 47.

In addition, the vacuum chamber 47 may be connected to the supplementary liquid injection hopper 43 through a liquid injection pipe 44b. The electrolyte accommodated in the supplementary liquid injection hopper 43 may be suctioned toward the vacuum chamber 47 due to a vacuum pressure of the vacuum chamber 47 and then introduced into the cell assembly 17 due to an action of gravity. The electrolyte inside the supplementary liquid injection hopper 43 may be transferred to the cell assembly via an internal space of the vacuum chamber 47 after passing through the liquid injection pipe 44b.

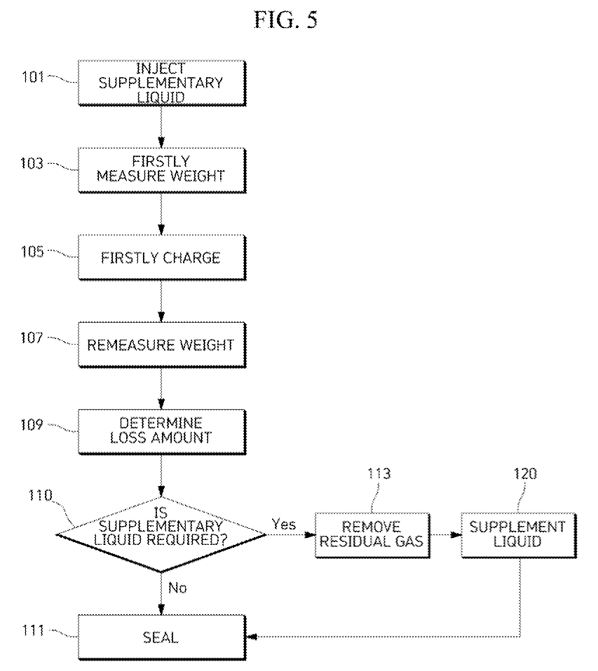

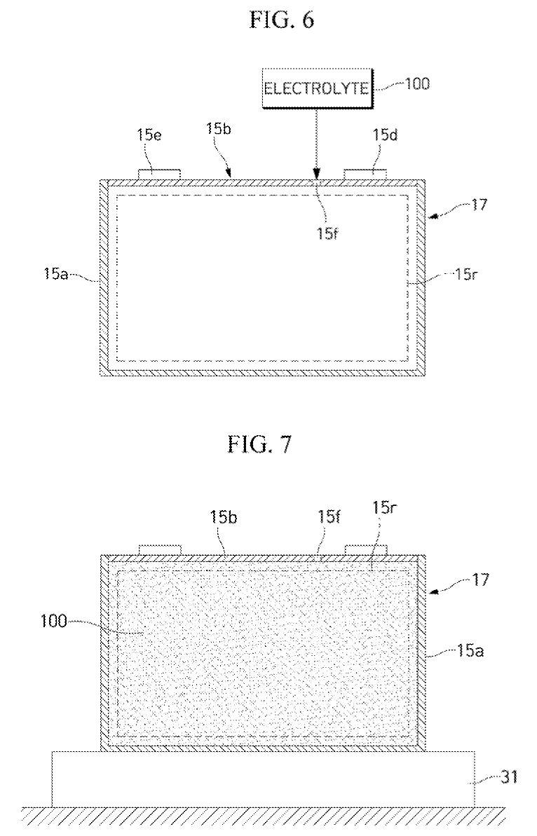

FIG. 5 is a flowchart illustrating a method of manufacturing a secondary battery according to one or more embodiments of the present disclosure, and FIGS. 6 to 11 are graphical diagrams illustrating the method of manufacturing a secondary battery according to one or more embodiments of the present disclosure.

As shown in the drawings, a method of manufacturing a secondary battery according to the present embodiment may include a first liquid injection operation 101, a first weight measurement operation 103, a first charging operation 105, a weight remeasurement operation 107, a loss amount determination operation 109, a residual gas removal operation 113, a supplementary liquid injection operation 120, and a sealing operation 111.

The first liquid injection operation 101 may be a process of injecting an electrolyte into the cell assembly 17 accommodating the electrode assembly 15r. That is, as shown in FIG. 4, the first liquid injector 32 is aligned with the electrolyte injection hole 15f to inject the electrolyte. An internal space of the battery can 15a is filled with the injected electrolyte and the electrode assembly 15r is immersed in the injected electrolyte.

The first weight measurement operation 103 may be a process of measuring a weight of the cell assembly 17 after the first liquid injection is completed. That is, the cell assembly 17 into which the electrolyte is injected is placed on the loss amount determination part 31 of FIG. 7, that is, a scale, to measure its weight. The weight measured in the loss amount determination part 31 may be the sum of weights of the cell assembly 17, the electrode assembly 15r, and the electrolyte 100. Data measured in the loss amount determination part 31 may be transmitted to the controller 49.

The subsequent first charging operation 105 is a process of applying power to the cell assembly 17, for which the first weight measurement operation 103 is completed, to perform first charging. As shown in FIG. 8, charging is performed by applying power while the charger 33, which is separately prepared, is connected to the cell assembly 17. As the first charging (in other words, initial charging or precharging) progresses, some of the electrolyte may be lost due to other reason such as a chemical reaction, resulting in a decrease in weight.

The weight remeasurement operation 107 is a process of remeasuring the weight of the cell assembly in a state in which the electrolyte is accommodated after the first charging operation 105 is completed. As the result of remeasuring the weight of the cell assembly, when no electrolyte supplement is required, the sealing operation 111 may be performed.

FIG. 9 shows that a liquid level of the electrolyte supplied inside the cell assembly 17 does not fall. In this way, when the electrolyte is not lost, the sealing operation 111 is performed immediately. The sealing operation 111 may be a process of sealing the electrolyte injection hole 15f. In comparison, as shown in FIG. 10, the liquid level of the electrolyte 100 may fall by as much as, for example, H. The falling of the liquid level, i.e., the electrolyte being lost, may be determined through the measured value of the loss amount determination part 31. The weight data measured in the loss amount determination part 31 may be transmitted to the controller 49.

The loss amount determination operation 109 is a process of determining a loss amount of the electrolyte according to the charging by comparing the remeasured weight with the first measured weight. The loss amount determination operation 109 may be performed through the loss amount determination part 31. The loss amount determination part 31 may determine the loss weight of the electrolyte.

As the determination result of the loss amount determination operation 109, when the electrolyte needs to be supplemented inside the cell assembly 17 (i.e., a query 110 is made as to whether supplemental liquid is required), the residual gas removal operation 113 may be performed.

The residual gas removal operation 113 is a process of removing a gas inside the cell assembly before the supplementary liquid injection operation 120 is performed. For example, when the vacuum chamber 47 is connected to the electrolyte injection hole 15f of the cell assembly 17, the gas remaining inside the cell assembly may be suctioned out of the cell assembly, thereby removing the gas inside the cell assembly 17.

The supplementary liquid injection operation 120 may be a process of supplementing the electrolyte into the battery can as much as the loss amount. To this end, the supplementary liquid injection unit 40 of FIG. 11 may be used. As described above, the supplementary liquid injection unit 40 may function to prepare the amount of the electrolyte as much as the lost amount and then supply the inside of the cell assembly 17 with the electrolyte after the gas is removed. After the supplementary liquid injection operation 120 is completed, the sealing operation 111 may be performed.

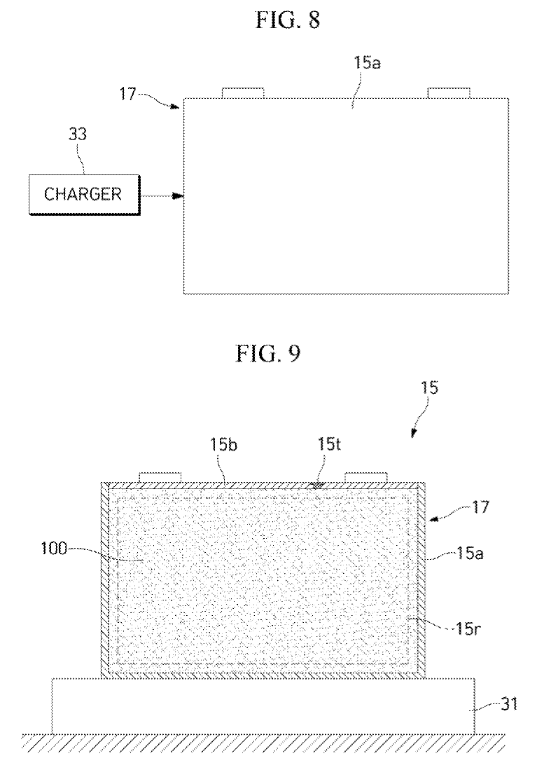

FIG. 12 is a block diagram illustrating a modified example of the apparatus 30 for manufacturing a secondary battery according to one or more embodiments of the present disclosure.

Hereinafter, the same reference numerals as the above-described reference numerals indicate the same components with the same functions.

As shown in FIG. 12, the apparatus 30 for manufacturing a secondary battery may include a first liquid injector 32, a charger 33, a loss amount determination part 31, and a supplementary liquid injection unit 40. In addition, the supplementary liquid injection unit 40 may include an electrolyte accommodation part 41, a pump 51, a flow meter 53, and a controller 49.

The supplementary liquid injection unit 40 may perform measurement of a lost electrolyte through the flow meter 53. For reference, in the case of FIG. 3, the measurement is performed using the load cell 45. The electrolyte accommodation part 41 and the cell assembly 17 may be connected to the liquid injection pipe 44b, and the flow meter 53 may be installed at the liquid injection pipe 44b together with the pump 51 and the flow rate control valve 48.

The pump 51 and the flow rate control valve 48 may be controlled by the controller 49. When the pump 51 operates, the electrolyte accommodated in the electrolyte accommodation part 41 may be supplied to the cell assembly 17 through the flow meter 53 and the flow rate control valve 48. The flow rate of the electrolyte transferred to the cell assembly 17 may be measured by the flow meter 53. In addition, measurement information from the flow meter 53 is transmitted to the controller 49 in real time.

The controller 49 is connected to the loss amount determination part 31 and the flow meter 53 and may supply the electrolyte as much as the calculated loss amount (e.g., may supply the electrolyte in an amount equal to the calculated loss amount) to the cell assembly through the loss amount determination part. The controller 49 determines a volume of the electrolyte supplied to the cell assembly using the loss amount information already received through the loss amount determination part 31, i.e., the weight information of the electrolyte to be supplemented to the cell assembly 17. For example, the controller 49 determines how many cc of the electrolyte to supplement. Since a density of the electrolyte is known and a weight and a mass may be assumed to be equal, the loss weight of the electrolyte may be converted into a volume. The controller 49 may block the valve 46 immediately after a flow rate of the electrolyte to be supplemented is supplied to the cell assembly 17.

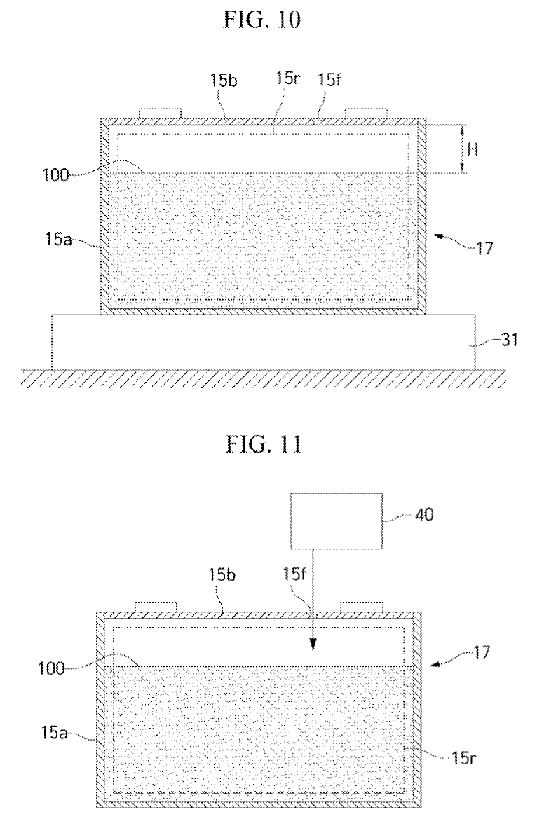

FIG. 13 is a diagram illustrating a modified example of the apparatus 30 for manufacturing a secondary battery shown in FIG. 12.

As shown in the drawing, the supplementary liquid injection unit 40 may further include a pressure regulator 55 and a vacuum chamber 47. The pressure regulator 55 and the vacuum chamber 47 may be connected to the cell assembly and may serve as a gas discharge port for discharging a gas inside the cell assembly.

The vacuum chamber 47 is connected to the cell assembly 17 through a discharge pipe 47a. In addition, the pressure regulator 55 may be connected to the vacuum chamber 47 to control a pressure inside the vacuum chamber 47. The pressure regulator 55 may be a vacuum pump. The pressure regulator 55 may be controlled by the controller 49. In addition, the liquid injection pipe 44b may be connected to the discharge pipe 47a.

When the discharge pipe 47a (see FIG. 3) is connected to the electrolyte injection hole 15f of the cell assembly 17, the gas inside the cell assembly 17 may be discharged to the outside of the cell assembly 17 under the action of a negative pressure. When the internal pressure of the vacuum chamber 47 is further reduced through the pressure regulator 55, the gas discharge may be accelerated.

When the pump 51 operates after the gas inside the cell assembly 17 is discharged, the electrolyte may be transferred to the cell assembly 17 via a partial section of the discharge pipe 47a after passing through the liquid injection pipe 44b.

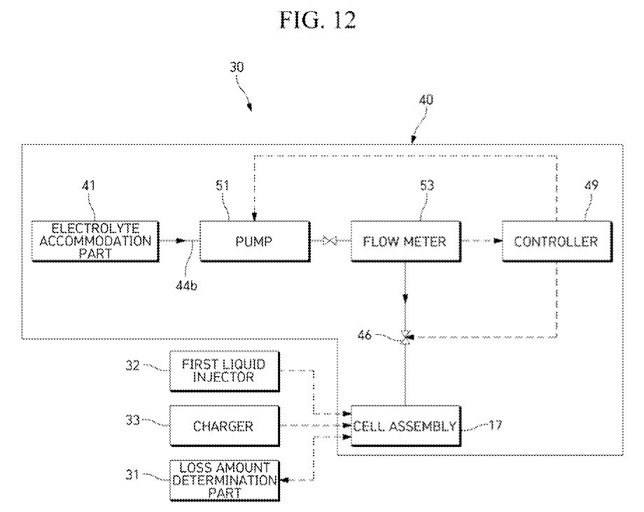

FIG. 14 is a diagram illustrating another modified example of the apparatus for manufacturing a secondary battery according to one or more embodiments of the present disclosure.

As shown in FIG. 14, only the pump 51 is installed at the liquid injection pipe 44b, and a weight change detector 61 may be installed below the cell assembly 17. The weight change detector 61 may measure the weight of the cell assembly 17 in real time while the electrolyte is injected into the cell assembly 17. That is, the weight change of the cell assembly may be measured in real time and the measured data may be transmitted to the controller 49.

The controller 49 is connected to the weight change detector 61 and may drive the pump until the weight measured by the weight change detector becomes equal to a weight of the cell assembly after the first liquid injection operation 101 of FIG. 5 is completed. The controller 49 may stop the pump 51 and block the valve 46 at an instant when the weight of cell assembly 17 becomes equal to the weight of the cell assembly at the time of the first injection.

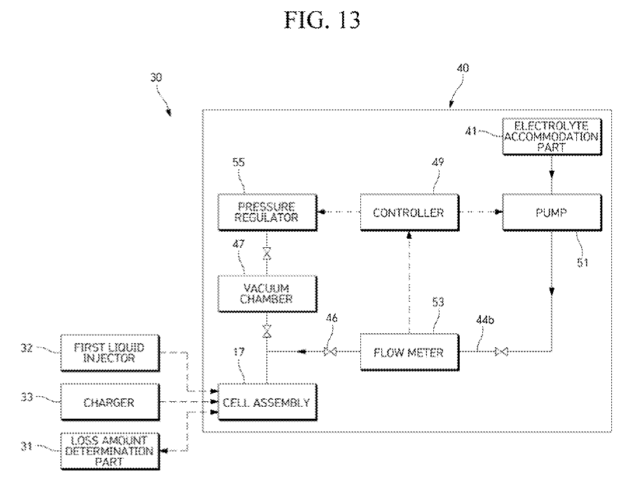

FIG. 15 is a diagram illustrating a modified example of the manufacturing apparatus shown in FIG. 14. As shown in FIG. 15, the vacuum chamber 47 and the pressure regulator 55 may be further applied to the cell assembly 17. Structures and operation methods of the vacuum chamber 47 and the pressure regulator 55 are the same as described in FIG. 13.

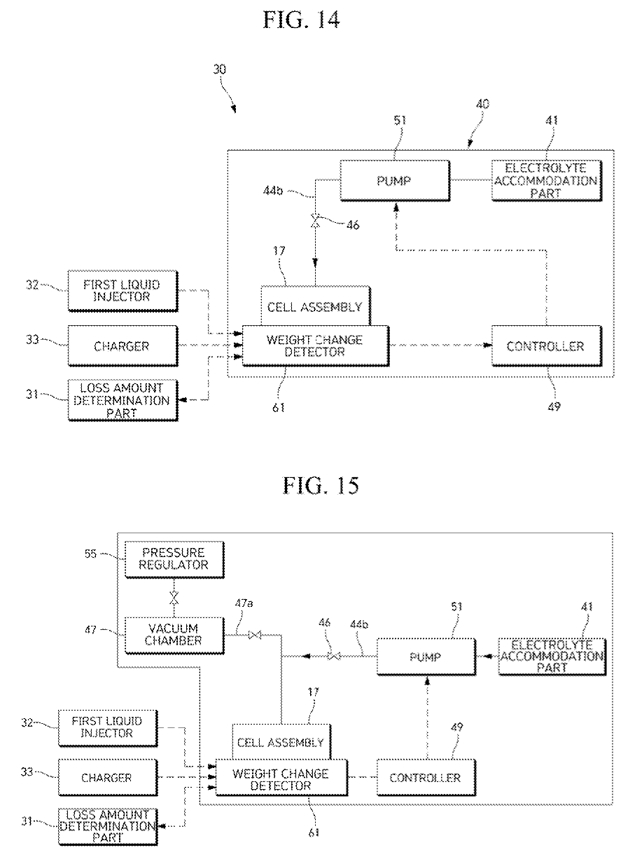

FIG. 16 is a diagram illustrating still another modified example of the apparatus for manufacturing a secondary battery according to one or more embodiments of the present disclosure.

As shown in FIG. 16, the supplementary liquid injection unit 40 may include the electrolyte accommodation part 41, the pump 51, a quantitative chamber 65, a volume detector 63, a quantitative injector 67, and the controller 49.

The quantitative chamber 65 may be connected to the electrolyte accommodation part 41 through the liquid injection pipe 44b. The electrolyte accommodation part 41 is a container that temporarily accommodates the electrolyte transferred through the pump 51. In addition, the volume of the electrolyte accommodated in the quantitative chamber 65 may be determined through the volume detector 63. The volume detector 63 may be a liquid level sensor installed in the quantitative chamber 65. The volume detector 63 may detect the volume of the electrolyte inside the quantitative chamber 65 and transmit the detection information to the controller 49.

The volume of the electrolyte accommodated in the quantitative chamber 65 may be controlled by the controller 49. The controller 49 may control the pump 51 to transfer a required volume of the electrolyte to the quantitative chamber 65. The controller 49 is connected to the loss amount determination part 31 and the volume detector 63 and may stop the pump when the volume of the electrolyte in the quantitative chamber becomes equal to the loss amount determined through the loss amount determination part 31. For example, when the loss amount of the electrolyte is 21cc, the electrolyte of 21 cc is collected inside the quantitative chamber 65.

The electrolyte collected in the quantitative chamber 65 may be supplied to the cell assembly 17 by the quantitative injector 67. The quantitative injector 67 may supply the electrolyte accommodated in the quantitative chamber 65 to the cell assembly. The quantitative injector 67 may be a pump.

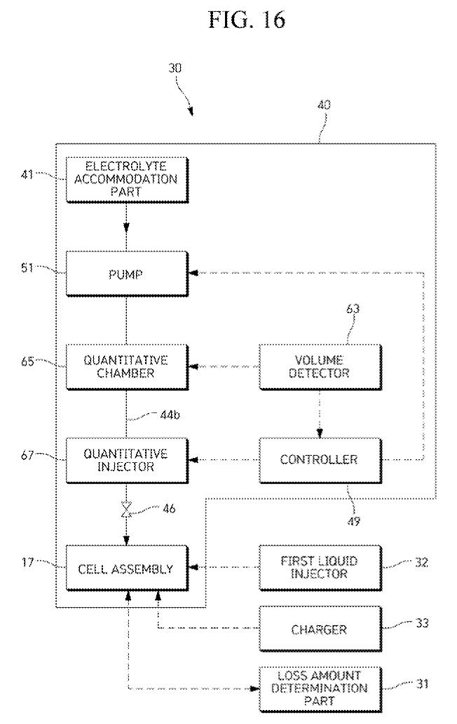

FIG. 17 is a diagram illustrating a modified example of the apparatus 30 for manufacturing a secondary battery shown in FIG. 16.

As shown in the drawing, the vacuum chamber 47 and the pressure regulator 55 may be connected to the cell assembly 17. Details regarding the vacuum chamber 47 and the pressure regulator 55 are the same as described in FIG. 13.

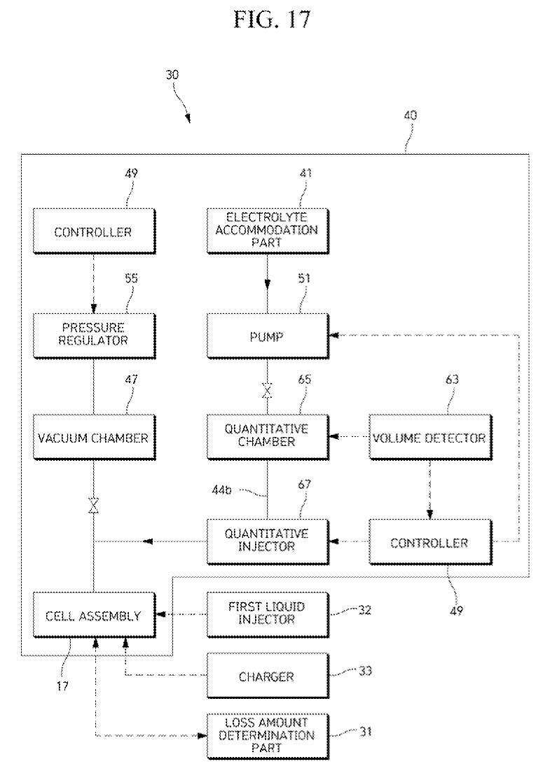

FIG. 18 is a perspective view illustrating a secondary battery pack having the secondary battery manufactured by the apparatus for manufacturing a secondary battery according to one or more embodiments of the present disclosure.

The secondary battery pack 20 may be manufactured by embedding a plurality of secondary battery modules in a pack housing designed to be mounted in an actual product. The pack housing may include fasteners and electrical outlets necessary for being mounted in the product. In FIG. 18, for convenience of illustration, bus bars for electrical connection of secondary batteries, cooling units, external terminals, and other related elements are omitted. The secondary battery pack may be mounted in a vehicle. The vehicle may be, for example, an electric vehicle, a hybrid vehicle, or a plug-in hybrid vehicle. The vehicle may include a four-wheel or two-wheel drive vehicle.

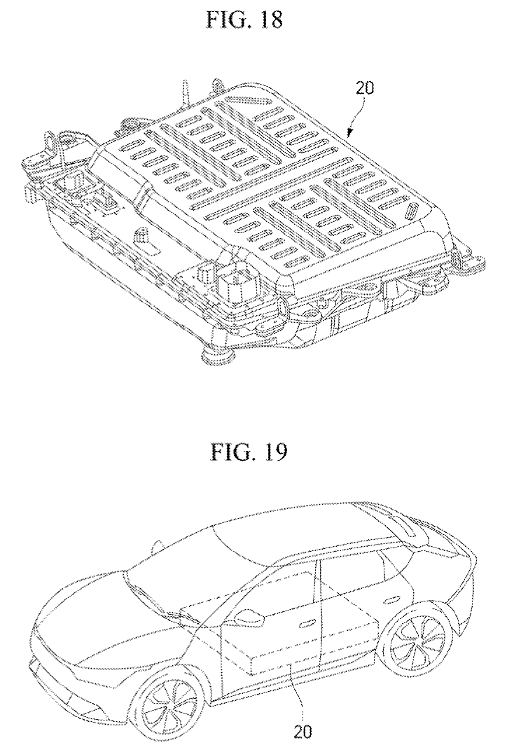

FIG. 19 is a diagram illustrating an application example of the secondary battery pack of FIG. 18.

FIG. 19 illustrates the secondary battery pack 20 according to one or more embodiments of the present disclosure mounted in a lower portion of a vehicle body of a vehicle. The vehicle operates by power received from the secondary battery pack 20 according to one or more embodiments of the present disclosure.

With the recent trend toward high-capacity of a secondary battery, an injection amount of an electrolyte injected into the battery can is increasing. However, in proportion as the injection amount of the electrolyte increases, a problem in which a loss amount of the electrolyte due to a temperature rise inside the battery can increases during precharging occurs. When the loss amount of the electrolyte increases, the performance of the secondary battery is degraded and a problem such as salt precipitation occurs. There is a need for a manufacturing apparatus and method that can manufacture a secondary battery outputting optimal performance by additionally injecting an electrolyte as much as loss by precharging.

According to an apparatus and method for manufacturing a secondary battery of the present disclosure, an electrolyte as much as a loss volume during precharging can be accurately supplemented so that performance degradation of the secondary battery can be prevented.

Although the present disclosure has been described above with respect to embodiments thereof, the present disclosure is not limited thereto. Various modifications and variations can be made thereto by those skilled in the art within the spirit of the present disclosure as defined by the appended claims and their equivalents.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated.Accordingly, it will be understood by those of skill in the art that various changes in form and details may be made without departing from the spirit and scope of the present invention as set forth in the following claims.

What is claimed is:

1. An apparatus for manufacturing a secondary battery, the apparatus comprising:
a first liquid injector for firstly injecting an electrolyte into an interior of a cell assembly comprising a cap assembly and a battery can, which are mutually connected, the battery can accommodating an electrode assembly therein;
a charger configured to charge the cell assembly after firstly injecting the electrolyte is completed;
a loss amount determination part configured to determine a change in weight of the cell assembly before and after charging and determine, resulting in a determination result, a loss amount of the electrolyte according to the charging based on the determination result; and
a supplementary liquid injection unit configured to supplement the electrolyte by the loss amount to the cell assembly.

2. The apparatus as claimed in claim 1, wherein the supplementary liquid injection unit comprises:
a measurement part configured to measure the electrolyte by the loss amount; and
a supplementary liquid injection hopper configured to accommodate the electrolyte measured by the measurement part and transfer the electrolyte to the cell assembly.

3. The apparatus as claimed in claim 2, wherein the measurement part comprises a weight measurement module configured to measure a weight of the supplementary liquid injection hopper.

4. The apparatus as claimed in claim 2, wherein the supplementary liquid injection unit further comprises:
an electrolyte accommodation part connected to the supplementary liquid injection hopper through a supply pipe and configured to transfer the electrolyte to the supplementary liquid injection hopper; and
a controller connected to the measurement part and the loss amount determination part, the controller being configured to control a flow rate of the electrolyte moving from the electrolyte accommodation part to the supplementary liquid injection hopper.

5. The apparatus as claimed in claim 4, wherein a flow rate control valve on the supply pipe is opened and closed by the controller.

6. The apparatus as claimed in claim 5, wherein the supplementary liquid injection unit further comprises a vacuum chamber connected to the cell assembly, the supplementary liquid injection unit being configured to discharge a gas inside the cell assembly.

7. The apparatus as claimed in claim 6, wherein:
the supplementary liquid injection hopper is connected to the vacuum chamber through a liquid injection pipe; and
the electrolyte inside the supplementary liquid injection hopper is transferred, after passing through the liquid injection pipe, to the cell assembly through the vacuum chamber.

8. The apparatus as claimed in claim 1, wherein the supplementary liquid injection unit comprises:
an electrolyte accommodation part connected to the cell assembly through a liquid injection pipe;
a pump configured to supply the electrolyte of the electrolyte accommodation part to the cell assembly;
a flow meter configured to measure a flow rate of the electrolyte moving to the cell assembly; and
a controller connected to the loss amount determination part and the flow meter, the controller being configured to supply the electrolyte by the loss amount calculated through the loss amount determination part to the cell assembly.

9. The apparatus as claimed in claim 8, wherein the supplementary liquid injection unit further comprises a gas discharge part connected to the cell assembly and configured to discharge a gas inside the cell assembly.

10. The apparatus as claimed in claim 9, wherein the gas discharge part comprises a vacuum chamber connected to the cell assembly through a discharge pipe.

11. The apparatus as claimed in claim 10, further comprising a pressure regulator configured to control a pressure of an interior of the vacuum chamber.

12. The apparatus as claimed in claim 1, wherein the supplementary liquid injection unit comprises:
an electrolyte accommodation part connected to the cell assembly through a liquid injection pipe;
a pump configured to supply the electrolyte of the electrolyte accommodation part to the cell assembly;
a weight change detector configured to detect a weight change of the cell assembly in real time; and
a controller connected to the weight change detector, the controller being configured to drive the pump until the weight measured by the weight change detector becomes equal to a weight of the cell assembly into which the first liquid injection is completed.

13. The apparatus as claimed in claim 12, wherein the supplementary liquid injection unit further comprises a gas discharge part connected to the cell assembly, the supplemental liquid injection unit being configured to discharge a gas inside the cell assembly.

14. The apparatus as claimed in claim 13, wherein the gas discharge part comprises a vacuum chamber connected to the cell assembly through a discharge pipe.

15. The apparatus as claimed in claim 1, wherein the supplementary liquid injection unit comprises:
an electrolyte accommodation part connected to the cell assembly through a liquid injection pipe;
a quantitative chamber configured to temporarily accommodate the electrolyte of the electrolyte accommodation part transferred by a pump;
a volume detector configured to measure a volume of the electrolyte inside the quantitative chamber;
a controller connected to the loss amount determination part and the volume detector, the controller being configured to stop the pump when the volume of the electrolyte inside the quantitative chamber becomes equal to a loss amount determined through the loss amount determination part; and
a quantitative injector configured to supply the electrolyte inside the quantitative chamber to the cell assembly.

16. The apparatus as claimed in claim 15, wherein the supplementary liquid injection unit further comprises a gas discharge part connected to the cell assembly, the supplemental liquid injection unit being configured to discharge a gas inside the cell assembly, which occurs during charging.

17. The apparatus as claimed in claim 16, wherein the gas discharge part comprises a vacuum chamber connected to the cell assembly through a discharge pipe.

18. A secondary battery manufactured by the apparatus for manufacturing a secondary battery as claimed in claim 1.

19. A method of manufacturing a secondary battery, the method comprising:
firstly injecting an electrolyte into an interior of a cell assembly comprising a cap assembly and a battery can, which are mutually connected, the battery can accommodating an electrode assembly therein;
measuring a first weight of the cell assembly after the firstly injecting is completed;
charging the cell assembly on which the first weight measurement operation is completed;
re-measuring a weight of the cell assembly after charging the cell assembly is completed, resulting in a re-measured weight;
comparing the re-measured weight with the first weight and determining a loss amount of the electrolyte according to the charging; and
supplementing the electrolyte by the loss amount into the battery can.

20. The method as claimed in claim 19, further comprising, before supplementing the electrolyte is performed, removing a gas inside the cell assembly.
